(19) United States
(12) Patent Application Publication
(10) Pub. No.: US 2024/0180201 A1
(43) Pub. Date: Jun. 6, 2024

(54) POWDER BEVERAGE

(71) Applicant: TOYO SHINYAKU CO., LTD., Fukuoka (JP)

(72) Inventors: Hiroya TAKAHASHI, Saga (JP); Yoshifumi KOSEKI, Saga (JP)

(73) Assignee: TOYO SHINYAKU CO., LTD., Fukuoka (JP)

(21) Appl. No.: 18/367,770

(22) Filed: Sep. 13, 2023

(30) Foreign Application Priority Data
Dec. 6, 2022 (JP) 2022-194794
Dec. 6, 2022 (JP) 2022-194795
Dec. 6, 2022 (JP) 2022-194796

(51) Int. Cl. A23L 2/02; A23L 2/395; A23L 5/30

(52) U.S. Cl. CPC A23L 2/02; A23L 2/395; A23L 5/30

(57) ABSTRACT

A powder beverage that includes at least one type of dark-green vegetable, wherein a dispersion time measured by the following procedure is 10 min or less: put 100 mL water in a container having a circular truncated cone shape, a bottom having an inner diameter of 55 mm, a top part having an inner diameter of 75 mm, and a height of 100 mm; inject the powder beverage from above 50 mm of the water surface at a rate of 1 g/sec; and measure the time (dispersion time) from when injection of the powder beverage is terminated to when the powder beverage floating on the liquid surface is submerged in the water.

### CROSS-REFERENCE TO RELATED APPLICATIONS

This application claims benefit of Japanese Application Nos. 2022-194794, 2022-194795 and 2022-194796 filed in Japan on Dec. 6, 2022, the contents of which are incorporated by this reference.

### BACKGROUND OF THE INVENTION

### Field of the Invention

The present invention relates to a powder beverage comprising at least one type of dark-green vegetable.

### Description of the Related Art

Dark-green vegetables are known to comprise nutrient components, such as vitamins, minerals and dietary fiber in abundance. Thus, dark-green vegetables are used in various foods and drinks, such as health food, supplements, and beverages. For example, Patent Reference 1 describes mineral functional water comprising wormwood (Artemisia indica).

As form of health foods or supplements comprising dark-green vegetable, there are many processed foods in powdered state. As for processed foods in powdered state, there are some that are intake in state of powder as it is, while there are some that are intake as beverages, by being mixed to liquid such as water or hot water, milk, soy milk, etc. In the present application, processed foods (including quasi-drugs and drug medicines) in powdered state supplied for drink as beverage, by being mixed in liquid such as water or hot water, milk, soy milk, etc. by a consumer at the time of intake are called powder beverage.

In powder beverage, since the action of dispersing into liquid such as water is performed by the consumer by himself (herself), from the viewpoint of reducing the work burden of the consumer, development of powder beverage having excellent dispersibility was awaited. However, powder beverages comprising dark-green vegetables that have been developed so far did not necessarily have excellent dispersibility. Particularly, when the content of dark-green vegetable is high, the dispersibility of the powder beverage was bad, and amelioration was awaited.

### PRIOR ART DOCUMENTS

<Patent document 1> US Patent Application Publication No. 2017/0118995

### SUMMARY OF THE INVENTION

### Technical Problem

The present invention has been made in view of the above-mentioned problems, and is intended to provide a powder beverage comprising at least one type of dark-green vegetable, and having excellent dispersibility.

### Solution to Problem

The present inventors have found out, in the process of developing powder beverage comprising dark-green vegetable, that by using dry powder of dark-green vegetable having a particular median diameter, or granulating dark-green vegetables by a particular method, a powder beverage having excellent dispersibility can be obtained. The present invention has been thus completed.

Specifically, the present invention is as follows.

[1] A powder beverage comprising at least one type of dark-green vegetable, wherein a dispersion time measured by the following procedure is 10 min or less:

### <Measurement Procedure of Dispersion Time>

Put 100 mL water in a container having a circular truncated cone shape, which inner diameter of a bottom part is 55 mm, inner diameter of a top part is 75 mm, and a height is 100 mm; inject a powder beverage from above 50 mm of a water surface at a rate of 1 g/sec; and measure the time (dispersion time) from when the injection of the powder beverage is terminated to when the powder beverage floating on a liquid surface is submerged in water.
[2] A powder beverage comprising at least one type of dark-green vegetable, wherein a dispersion distance after stirring for 1 min as measured by the following procedure is less than 10 mm:

### <Measurement Procedure of Separation Distance>

Put 100 ml of water in a transparent container having a cylindrical shape, which inner diameter is 75 mm, inject a powder beverage from 50 mm above a water surface at a rate of 1 g/sec, stirring 10 times using a stick which diameter is 5 mm, so as to draw a radius of 25 mm from a center of the container; remove the stick when terminating stirring, allow to stand still for 1 min, and measure a height (separation distance) of a clear upper portion.
After injecting the powder beverage, stirring is started within 3 sec, and the stirring rate is 1 to 1.5 times/sec. When stirring the tip of the stick shall contact the bottom of the container.
[3] The powder beverage according to [1], further wherein a separation distance 1 min after stirring as measured by the following procedure is less than 10 mm:

### <Measurement Procedure of Separation Distance>

Put 100 ml of water in a transparent container having a cylindrical shape, which inner diameter is 75 mm, inject a powder beverage from 50 mm above a water surface at a rate of 1 g/sec, stirring 10 times using a stick which diameter is 5 mm, so as to draw a radius of 25 mm from a center of the container; remove the stick when terminating stirring, allow to stand still for 1 min, and measure a height (separation distance) of a clear upper portion.
After injecting the powder beverage, stirring is started within 3 sec, and the stirring rate is 1 to 1.5 times/sec. When stirring the tip of the stick shall contact the bottom of the container.
[4] The powder beverage according to [1], wherein the dark-green vegetable is a dry powder.
[5] The powder beverage according to [1], wherein the dark-green vegetable is a crushed powder.
[6] The powder beverage according to [1], wherein the dark-green vegetable is at least one selected from oats, kale, ocarina, mulberry, Angelica keiskei, wormwood, Peucedanum japonicum, Kuma Bamboo Grass, spinach, Swiss chard, and celery.
[7] The powder beverage according to [1], wherein the dark-green vegetable is a young barley grass.
[8] The powder beverage according to [1], wherein the dark-green vegetable is a young barley grass crushed powder.
[9] The powder beverage according to [8], wherein the young barley grass crushed powder has a median diameter of 30 μm or less.
[10] The powder beverage according to [8], wherein the young barley grass crushed powder has a median diameter of 25 μm or less.
[11] The powder beverage according to [1], wherein the powder beverage is a granulated product.
[12] The powder beverage according to [1], wherein the dark-green vegetable has a content of 10% by weight or more.
[13] A method for producing a powder beverage comprising a dark-green vegetable according to [1], comprising granulating the dark-green vegetable by a fluidized-bed granulation.
[14] A method for producing a powder beverage comprising a dark-green vegetable according to [1], comprising a step of crushing the dark-green vegetable to obtain a crushed powder of dark-green vegetable, and a step of injecting the crushed powder of dark-green vegetable in a fluidized-bed granulator, supplying air for fluidization, spraying water, and then drying to obtain a granulated product.
[15] A method for maintaining or improving a function of intestinal regulation, comprising administering the powder beverage according to [7] to human.
[16] A method for ameliorating bowel movement, comprising administering the powder beverage according to [7] to human.
[17] A method for ameliorating intestinal environment, comprising administering the powder beverage according to [7] to human.
[18] A method for proliferating intestinal lactic acid bacteria, comprising administering the powder beverage according to [7] to human.
[19] A method for proliferating intestinal butyric acid bacteria, comprising administering the powder beverage according to [7] to human.
[20] A method for maintaining or improving immunity, comprising administering the powder beverage according to [7] to human.
[21] A method for promoting IgA secretion, comprising administering the powder beverage according to [7] to human.

### Advantageous Effects of Invention

According to the present invention, by using dry powder of dark-green vegetable having a particular median diameter as dark-green vegetables, or granulating dark-green vegetables by a particular method, a powder beverage having excellent dispersibility can be provided.

### DESCRIPTION OF EMBODIMENTS

The present invention is explained in detail in the following.

### [1. Dark-Green Vegetables]

The dark-green vegetables of the present invention relate to vegetables having green color, specifically include green leaves of plants such as oats, kale, ocarina, mulberry, Angelica keiskei, wormwood, Peucedanum japonicum, Kuma Bamboo Grass, spinach, Swiss chard, celery, cabbage, colored green, lettuce, carrot, and tea, and vegetables such as pepper, goya, Japanese mustard spinach, green onion, Chinese chive, Broccoli, and peas. Parts of dark-green vegetables used in the present invention are not limited as long as it includes parts having green color, and for example, leaves, stem, and berries can be used.

As dark-green vegetables of the present invention, plants belonging to any family can be used, and for examples plants of Granmineae, Brassicaceae, Amaranthaceae, Apiaceae, Convolvulaceae, Moraceae, Asteraceae, and Chenopodiaceae can be used. From the viewpoint of having excellent dispersibility and drinkability when used as powder beverage, and the viewpoint of comprising nutrient components in abundance, plants of Granmineae, Brassicaceae, Amaranthaceae, Apiaceae are more preferable, plants of Granmineae, Brassicaceae, Amaranthaceae are particularly preferable, and plants of Granmineae are most preferable.

As dark-green vegetables of the present invention, plants belonging to any genus can be used, and for examples plants of Granmineae Hordeum, Granmineae Sasa, Brassicaceae Brassica, Amaranthaceae Spinacia, Apiaceae Angelica, Apiaceae Peucedanum, Apiaceae Apium, Convolvulaceae Ipomoea, Moraceae Morus, Asteraceae Artemisia, Chenopodiaceae Beta, etc. can be used. From the viewpoint of having particularly excellent dispersibility and drinkability when used as powder beverage, and the viewpoint of comprising nutrient components in abundance, plants of Granmineae Hordeum, Granmineae Sasa, Brassicaceae Brassica, Amaranthaceae Spinacia are more preferable, plants of Granmineae Hordeum, Granmineae Sasa, Brassicaceae Brassica, Amaranthaceae Spinacia are more preferable, and plants of Granmineae Hordeum are most preferable.

### [2. Green Leaves of Specific Plants]

As dark-green vegetables of the present invention, any dark-green vegetables can be used. However, from the viewpoint of having particularly excellent dispersibility and drinkability when used as powder beverage, and the viewpoint of comprising nutrient components in abundance, it is particularly preferable to use green leaves of specific plants as described in the following as dark-green vegetables. Specific plants of the present invention mean at least one plant selected from oats, kale, ocarina, mulberry, Angelica keiskei, wormwood, Peucedanum japonicum, Kuma Bamboo Grass, spinach, Swiss chard and celery. Only one type can be used, but two or more types can be also used. From the viewpoint of having particularly excellent dispersibility and drinkability when used as powder beverage, and the viewpoint of comprising nutrient components in abundance, among green leaves of specific plants, green leaves of oats are particularly preferable, and green leaves of barley (young barley grass) are most preferable.

Green leaves of specific plants of the present invention relate to plant body including leaf part of the specific plant, and can include leaves, as well as stem, or other parts. Since it takes effort to remove stem from the aerial part at the time of harvest, and the stem part also comprises nutrient components such as insoluble dietary fiber, etc. in abundance, from the viewpoint of reducing manufacturing cost and the viewpoint of alibility, it is preferable to comprise stem together with leaves.

### <Oats>

Oats of the present invention mean a collective term of gramineous plant having similar appearance, such as barley, wheat, rye, oat, etc. As oats of the present invention, barley is particularly preferable.

Barley (Hordeum vulgare L.) is said to be native of Central Asia, is a poaceous annual or biennial grass plant belonging to Granmineae Hordeum. As barley used in the present invention, breed is not particularly limited. Barley of any breed can be used, and even wild species or crossbred can be used. For example, two-row barley, six-row barley, naked barley etc. can be exemplified, and these can be used by combining one or more breeds.

Green leaves of oats can be any one harvested at any harvest season, and are not particularly limited. For example, when oats are barley, it is preferable to use those harvested before mature stage, specifically those harvested from initiation of tillering stage to before initiation of ear emergence (young barley grass). Specifically, it is preferable to use young barley grass harvested from barley having a height of 10 cm or more, preferably about 10 to 90 cm, particularly preferably about 20 to 80 cm, best of all about 30 to 70 cm.

### <Kale>

Kale of the present invention means a plant of Brassicaceae Brassica, which scientific name is Brassica oleracea var. acephala. Breed of kale is not particularly limited, and various types of kale such as Kitchen Kale, Tree Kale, Bush Kale, Marrow Kale, Collard (can be referred to as collard green), Green leaf kale, etc. can be used. Green leaves of kale can be any one harvested at any harvest season, and are not particularly limited.

### <Ocarina>

Ocarina of the present invention means a plant of Convolvulaceae Ipomoea, which scientific name is Ipomea batatas. Ocarina is not particularly limited as long as it is one generally called sweet potato. Breed of ocarina is not particularly limited, and for example, breeds such as Suio, Joy White, Kogane-sengan, Shiroyutaka, Satsuma starch, Ayamurasaki can be exemplified. Among these, Suio having a high polyphenol content is preferable. Green leaves of ocarina can be any one harvested at any harvest season, and are not particularly limited. Tip part of stem and leaf (young stem and leaf) is preferable, and young stem and leaf in a state maintaining yellow-tinged green color is further preferable.

### <Mulberry>

Mulberry of the present invention means a plant of Moraceae Morus (genus Morus). Species of mulberry are not particularly limited, and Morus alba, Morus Australia, Morus lhou, Morus laevigata, Morus tiliaefolia, Morus boninensis, Morus serrata, etc. can be used. Green leaves of mulberry can be any one harvested at any harvest season, and are not particularly limited.

<Angelica keiskei>

Angelica keiskei of the present invention means a plant of Apiaceae Angelica. Breed of Angelica keiskei is not particularly limited and can be appropriately used. Green leaves of Angelica keiskei can be any one harvested at any harvest season, and are not particularly limited.

### <Wormwood>

Wormwood of the present invention means perennial plant of Asteraceae Artemisia (genus Artemisia). Species of wormwood are not particularly limited, and Artemisia indica, Artemisia absinthium, Artemisia dracunculus, Nitrof wormwood, Artemisia congesta, Artemisia capillaris, Artemisia japonica, Artemisia scoparia, Artemisia apiacea, Artemisia annua, Artemisia keshkeana, Artemisia pedenculosa, Artemisia trifucata, Artemisia arctica, Artemisia sinanensis, Artemisia glomerata, Artemisia lacinata, Artemisia stelleriana, Artemisia iwayomogi, Artemisia feddei, Artemisia gilvescens, Artemisia dubia, Artemisia monophylla, Artemisia unalaskensis, Artemisia koidzumii, Artemisia stolonifera, Artemisia momiyamae, Artemisia ruburipes, Artemisia montana, Artemisia indica, Artemisia schmidtiana, Artemisia kitadakensis, etc. can be used. Among these, Artemisia indica is particularly preferable. Green leaves of Artemisia indica can be any one harvested at any harvest season, and are not particularly limited.

<Peucedanum japonicum>

Peucedanum japonicum of the present invention means a plant of Apiaceae Pternopetalum. Peucedanum is called Danboufu, Chomeiso, Chomeigusa, Chomifusa, Bofu, Sakuna, Ububasafuna, Chomigusa, Botanbofu depending on the region. Breed of Peucedanum japonicum is not particularly limited, and can be appropriately used. Green leaves of Peucedanum japonicum can be any one harvested at any harvest season, and are not particularly limited.

### <Kuma Bamboo Grass>

Kuma Bamboo Grass of the present invention means a plant of Sasa beitchii (genus Sasa). Species of Kuma Bamboo Grass are not particularly limited, and Sasa veitchii, Sasa kurilensis, Sasamorpha borealis, Sasa senanensis, Sasa palmata, Sasa niponica, etc. can be used. Green leaves of Kuma Bamboo Grass can be any one harvested at any harvest season, and are not particularly limited.

### <Spinach>

Spinach of the present invention means a plant of Amaranthaceae Spinacia, which scientific name is Spinacia oleracea. Breed of spinach is not particularly limited, and can be appropriately used. Green leaves of spinach can be any one harvested at any harvest season, and are not particularly limited.

### <Swiss Chard>

Swiss chard of the present invention means a plant of Chenopodiaceae Beta, which scientific name is Beta vulgaris. In Japan, it is also called Fudanso. Breed of Swiss chard is not particularly limited, and can be appropriately used. Green leaves of Swiss chard can be any one harvested at any harvest season, and are not particularly limited.

### <Celery>

Celery of the present invention means a plant of Apiaceae Apium, which scientific name is Apium graveolens. Breed of celery is not particularly limited, and can be appropriately used. Green leaves of celery can be any one harvested at any harvest season, and are not particularly limited.

### [3. Dry Powder of Dark-Green Vegetables]

As dark-green vegetables used for powder beverage of the present invention, dry powder of dark-green vegetables can be used. Dry powder of dark-green vegetable of the present invention means those made by processing dark-green vegetables and dried and powderized. Examples of dry powder of dark-green vegetables include those made by crushing dark-green vegetables and dried and powderized (crushed powder of dark-green vegetables), those made by drying and powderizing juice of dark-green vegetables (juice powder of dark-green vegetables), and those made by drying and powderizing extract of dark-green vegetables (extract powder of dark-green vegetables), but it is not limited to these. As dry powder of dark-green vegetables of the present invention, it is preferable to be crushed powder of dark-green vegetables from the viewpoint of having excellent dispersibility and drinkability, the viewpoint of easiness of processing, storage, transport, etc. and the viewpoint of comprising dietary fiber in abundance. Since crushed powder of dark-green vegetables comprise a lot of insoluble components such as insoluble dietary fiber, it is common that the dispersibility worsens when mixing crushed powder of dark-green vegetables in powder beverages. However, by using the technique of the present invention, though it comprises crushed powder of dark-green vegetables, powder beverage having excellent dispersibility can be obtained.

As crushed powder of dark-green vegetables of the present invention, those obtained for example by combining drying treatment and crushing treatment can be used. Drying treatment and crushing treatment can be performed at the same time, or either one can be performed before the other one. However, it is preferable to first perform drying treatment, and then perform crushing treatment. According to need, one or more treatments selected from treatment s blanching treatment and disinfection treatment can be performed in combination. The number of times for performing crushing treatment is not particularly limited, and it can be performed as one or more treatments, such as after performing coarse crushing treatment, performing fine crushing for crushing more finely.

Blanching treatment is a treatment to keep the green color of dark-green vegetables bright, and examples of a method of blanching treatment include hot-water treatment and steaming treatment.

Examples of hot-water treatment include a method of treating dark-green vegetables in hot water or moisture of for example 70 to 100° C., preferably 80 to 100° C., for 60 to 240 sec, preferably for 90 to 180 sec. As steaming treatment, an intermittent steaming treatment of repeating a treatment of steaming dark-green vegetables with moisture and a treatment of cooling at normal pressure or under pressure is preferable.

Disinfection treatment is not particularly limited as long as it is a disinfection treatment commonly known to a person skilled in the art. For example, it can be a treatment of killing microorganisms physically or chemically by using temperature, pressure, electromagnetic wave, drugs, etc.

When performing blanching treatment additionally to drying treatment and crushing treatment, it is preferable that blanching treatment: performed before drying treatment. Further, when performing disinfection treatment additionally to drying treatment and crushing treatment, it is preferable that disinfection treatment is performed after drying treatment, or before or after crushing treatment.

Drying treatment is not particularly limited, but examples include treatment of drying so that the water content of dark-green vegetables becomes 10% by weight or less, preferably 8% by weight or less.

Crushing treatment is not particularly limited, but examples include treatment of crushing plant bodies by an arbitrary method that a person skilled in the art commonly uses. When performing crushing treatment, it is preferable to perform the treatment by combining coarse crushing and fine crushing, from the viewpoint of increasing crushing efficiency, such as to make the particle size uniform, shortening the crushing time, etc.

As juice powder of dark-green vegetables of the present invention, for example, those obtained by concentrating juice of dark-green vegetables at low temperature to concentrate the solid content, and lyophilizing or spray drying the concentrated liquid can be used.

### [Median Diameter of Dry Powder of Dark-Green Vegetables]

Median diameter dry powder of dark-green vegetables used in the present invention is not particularly limited, but when using dry powder of dark-green vegetables which median diameter is 30 μm or less, powder beverage having excellent dispersibility can be obtained, even without granulation. Median diameter is the particle size being 50% cumulative (volume) of particle size distribution of the powder. Median diameter of dry powder of dark-green vegetables is preferably 30 μm or less, more preferably 25 μm or less, particularly preferably 23 μm or less, and more particularly 20 μm or less, from the viewpoint of significantly improving dispersibility. Median diameter of dry powder of dark-green vegetables can be adjusted by for example, appropriately changing the conditions of crushing treatment in the crushing process of dark-green vegetables, or by appropriately changing the conditions of powderizing treatment in the production of dry powder of juice, or dry powder of extract.

For the measurement of median diameter of dry powder of dark-green vegetable, for example, laser scattering particle size distribution analyzer, specifically LMS-300 or LMS-3000 manufactured by Seishin Enterprise Co., Ltd. can be used. As dispersion medium used when measuring median diameter, a medium in which dry powder of dark-green vegetables does not swell can be appropriately selected, but when dry powder of dark-green vegetables is dark-green vegetable crushed powder, ethanol shall be used as dispersion medium.

As stated in the following, when using young barley grass powder which median diameter is 30 μm or less as dark-green vegetables, a particularly excellent effect of intestinal regulation, and/or effect of improving maintenance of immune function is exerted. From the viewpoint of exerting more significantly the effect of intestinal regulation, and/or effect of improving maintenance of immune function, median diameter of young barley grass powder is preferably 30 μm or less, more preferably 25 μm or less, particularly preferably 23 μm or less, more particularly preferably 20 μm or less, and most preferably 19 μm or less. The lower limit of median diameter of young barley grass powder is not particularly limited, but from the viewpoint of easiness of production, it is preferably 5 μm or more, more preferably 7 μm or more, and particularly preferably 10 μm or more.

### [5. Granulated Product Comprising Dark-Green Vegetables]

Granulation means an operation of agglomerating plural particles, to form an aggregate. In the aggregate (granulated product), a void is formed between particles when particles agglomerate, and there is a structural difference between granulated product (also called granules) and particles of raw materials used for granulation. Granulated products can be further mixed with raw materials other than dark-green vegetables such as excipient and sweetener. The granulated product of the present invention is not particularly as long it is an agglomerate in which plural particles are agglomerated, and the size of granulated product is not particularly limited.

The powder beverage of the present invention may not be granulated, but by granulating by using a particular method of granulation, a powder beverage having excellent dispersibility can be obtained. Examples of particular methods of granulation specifically include fluidized-bed granulation. Fluidized-bed granulation is a method of applying air to powder particles being the raw material to fluidize by aerial flow, while spraying coupling liquid such as water to attach powder particles to each other, to form a granulated product being agglomerate of powder particles.

Conventionally, in case where a lot of dark-green vegetables (particularly crushed powder of green leaves of specific plants) were contained, granulation was difficult, and even when dark-green vegetables could be granulated, there was no benefit such as improving dispersibility, and it was thought to just increasing the manufacturing cost. However, the present inventors found out that by granulating by fluidized-bed granulation, even in case of containing crushed powder of dark-green vegetables at a high content, it is possible to granulate, and that granulated products having excellent dispersibility can be obtained. The reason why the dispersibility of the obtained granulated products is different depending on method of granulation is not clear, but it is estimated that since the binding state of particles constituting the granulated products, or the size or shape of void formed between the particles differs depending on method of granulation, the structural difference affects the dispersibility.

In case of fluidized-bed granulation, according to a production method comprising a step of injecting dark-green vegetables to be the raw material in a fluidized-bed granulator, spraying water on the raw material having been fluidized by supplying air, and then drying to obtain a granulated product, granulated products having excellent dispersibility can be obtained. As fluidized-bed granulator used for granulation, an arbitrary granulator available in the market can be used.

The temperature of air to supply when fluidizing the raw material is not particularly limited, and can be appropriately adjusted according to the properties of raw material to be used. For example, it is preferably 50 to 75° C., more preferably 50 to 70° C., and particularly preferably 50 to 60° C. In a fluidized-bed granulator, the temperature of air to supply can be set. For example, when intending to supply air of 50° C., the setting temperature of the fluidized-bed granulator just has to be set at 50° C.

In fluidized-bed granulation, the amount of water to spay is not particularly limited, and can be appropriately adjusted according to the properties of raw material to be used. For example, the lower limit of the amount of water to spray is preferably 20% by weight or more with respect to the total weight of the raw material, more preferably 30% by weight or more, furthermore preferably 40% by weight or more, particularly preferably 45% by weight or more, and most preferably 50% by weight or more. Further, for the upper limit of the amount of water to spray is preferably 300% by weight or less with respect to the total weight of the raw material, more preferably 250% by weight or less, furthermore preferably 200% by weight or less, particularly preferably 150% by weight or less, and most preferably 100% by weight or less, from the viewpoint of shortening the drying time to improve productivity. In case granulated products contain raw materials other than dark-green vegetables, the amount of water to spray is an amount with respect to the total weight including raw materials other than dark-green vegetables.

In fluidized-bed granulation, granulation step can be performed only once, or can be performed plural times. The granules of the present invention having excellent dispersibility and drinkability can be obtained with a single granulation step, or with plural granulation steps. It is more preferable to perform a single granulation process from the viewpoint of producibility, etc.

In fluidized-bed granulation, after performing a step of spraying water on fluidized raw material, there is a step of drying to obtain granulated products (drying step). The temperature of air supplied during drying is not particularly limited, and can be appropriately adjusted according to the properties of raw material to be used. For example, it is preferably 80° C. or more, more preferably 90° C. or more, furthermore preferably 100° C. or more, and particularly preferably 110° ° C. or more. In a fluidized-bed granulator, the temperature of air to be supplied can be set, and for example when intending to supply air of 90° C., the setting temperature of the fluidized-bed granulator has just to be set at 90° C. The water content of the obtained granulated products is not particularly limited, but it is preferably 10% by weight or less, more preferably 9% by weight or less, and most preferably 8% by weight or less.

### [6. Powder Beverage]

The present invention is characterized by being powder beverage. The powder beverage of the present invention means a processed food in powdered state, supplied for drink as beverage, by being mixed to liquid such as water or hot water, milk, soy milk, by a consumer at the time of intake. In the present application, powder means a solid substance in fine powdered state, and is a concept comprising granulated products which have been granulated (granules). The form of the powder beverage of the present invention is not particularly limited, and examples include foods and drinks, quasi-drugs, drug medicines, etc. From the viewpoint of intaking dark-green vegetables on a daily basis to supplement daily nourishment, it is preferable to use as foods and drinks. The form of foods and drinks is not particularly limited, examples include and health food, supplement, foods indicated with functionality, etc. The manufacturing method of the powder beverage of the present invention is not particularly limited, and powder beverage obtained by any manufacturing method corresponds to the powder beverage of the present invention, as long as it satisfies the condition of dispersibility.

The powder beverage of the present invention can be appropriately added with additives such as binding agent, excipient, thickening agent, etc. according to need additionally to dark-green vegetables. The types of additives are not particularly limited, and examples include, for example, sugars such as glucose, maltitol, erythritol, etc., polysaccharide thickeners such as guar gum, etc., starch such as corn starch, etc., starch degradant such as dextrin and non-digestible dextrin, etc. Only one type of additive can be added, or two or more types can be added.

When the powder beverage of the present invention comprises green leaves of specific plant, the content of green leaves of specific plant in the powder beverage is not particularly limited. However, when the content of green leaves of specific plant is high, there is a merit that more green leaves of specific plant can be intake, as compared to when the content is low, even if the total amount of powder beverage is the same. From the viewpoint that nutrient components can be efficiently intake, it is preferable that the content of green leaves of specific plant is high, and for example, as dry weight, it can be 10% by weight or more, preferably 20% by weight or more, more preferably 30% by weight or more, further more preferably 50% by weight or more, furthermore more preferably 80% by weight or more, particularly preferably 90% by weight or more, and most preferably 100% by weight. Similarly, from the viewpoint that nutrient components can be efficiently intake, among the raw materials mixed in the powder beverage, it is preferable that the content of green leaves of specific plant is the highest.

Among the green leaves of specific plant, green leaves of oats have particular excellent taste and nutrition, it is preferable that among the raw materials mixed in the powder beverage of the present invention, the content of green leaves of oats is the highest.

### [7. Dispersibility]

Dispersibility of powder beverage of the present invention is a concept encompassing (1) rate (dispersion rate) with which the powder beverage injected in liquid such as water is dispersed in the liquid, and (2) that the powder beverage dispersed in the liquid is hardly separated (dispersion stability). In the present invention, the powder beverage having excellent dispersibility means that the dispersion rate and/or dispersion stability is excellent. The powder beverage of the powder beverage of the present invention is characterized of being excellent in at least one selected from dispersion rate and dispersion stability. From the viewpoint of reducing work burden of the consumer to perform at the time of intake (work to disperse the powder beverage in the liquid), it is particularly preferable that it is a powder beverage being excellent in both.

### (1) Dispersion Rate

As stated in the above, dispersion rate means a rate with which the powder beverage injected in liquid such as water is dispersed in the liquid. The dispersion rate can be assessed with the time (dispersion time) from injecting the powder beverage in water to when the powder beverage floating on a liquid surface is submerged in water. Specifically, dispersion time is measured by the following procedure.

### <Measurement Procedure of Dispersion Time>

Put 100 mL water in a container having a circular truncated cone shape, which inner diameter of a bottom part is 55 mm, inner diameter of a top part is 75 mm, and a height is 100 mm; inject 1 g of powder beverage from above 50 mm of a water surface at a rate of 1 g/sec; and measure the time (dispersion time) from when the injection of the powder beverage is terminated to when the powder beverage floating on a liquid surface is submerged.

Shorter is the dispersion time, excellent is the dispersibility of the powder beverage. In the present application, the powder beverage having excellent dispersion rate means that the dispersion rate measured by the above-mentioned method is 10 min or less. The powder beverage having excellent dispersion rate is not particularly limited as long as the dispersion rate is 10 min or less, but from the viewpoint of reducing work burden of the consumer to perform at the time of intake (work to disperse the powder beverage in the liquid), it is preferably 5 min or less, more preferably 3 min or less, particularly preferably 2 min or less, and most preferably 1 min or less.

### (2) Dispersion Stability

As stated in the above, dispersion stability means that the powder beverage dispersed in the liquid is hardly separated. Dispersion stability can be assessed by the height (separation distance) of clear upper portion after allowing the powder beverage mixed in water to stand still for a certain time. Specifically, separation distance is measured by the following procedure.

### <Measurement Procedure of Separation Distance>

Put 100 ml of water in a transparent container having a cylindrical shape, which inner diameter is 75 mm, inject a powder beverage from 50 mm above a water surface at a rate of 1 g/sec, stirring 10 times using a stick which diameter is 5 mm, so as to draw a radius of 25 mm from a center of the container; remove the stick when terminating stirring, allow to stand still for 1 min, and measure a height (separation distance) of a clear upper portion;

After injecting the powder beverage, stirring is started within 3 sec, and the stirring rate is 1 to 1.5 times/sec. When stirring the tip of the stick shall contact the bottom of the container.

Smaller is the separation distance, excellent is the dispersion stability of the powder beverage. In the present application, the powder beverage having excellent dispersion stability means that the separation distance measured by the above-mentioned method is less than 10 mm. The powder beverage having excellent dispersion stability is not particularly limited as long as the separation distance is less than 10 mm, but from the viewpoint of reducing work burden of the consumer to perform at the time of intake (work to disperse the powder beverage in the liquid), it is preferably less than 7 mm, more preferably less than 6 mm, particularly preferably less than 5 mm, and most preferably less than 3 mm.

### [8. Use Intending Effect of Intestinal Regulation, or Improving Maintenance of Immune Function]

When using young barley grass as dark-green vegetable of the present invention, effect of intestinal regulation, and/or effect of improving maintenance of immune function is exerted. Particularly, when using young barley grass powder (young barley grass crushed powder) having a median diameter of 30 μm or less, a more excellent effect of intestinal regulation, and/or effect of improving maintenance of immune function is exerted. Therefore, the powder beverage comprising young barley grass of the present invention can also be used for the purpose of obtaining an effect of intestinal regulation, or effect of improving maintenance of immune function.

### (1) Use Intending Effect of Intestinal Regulation

Since the powder beverage comprising young barley grass of the present invention exerts an effect of intestinal regulation, it can be used as a composition for intestinal regulation. When using as a composition for intestinal regulation, it is not particularly limited as long as it can be distinguished from other products as product as being used for intestinal regulation. Those with an indication of having an effect of intestinal regulation on any of the main body, package, instructions, advertisement of the product of the present invention are encompassed. Embodiment of using the powder beverage comprising young barley grass of the present invention as a composition for intestinal regulation is not limited to those with an indication of comprising young barley grass as active ingredients for intestinal regulation on the package of the product, etc. For example, it can be one indicating a particular ingredient (dietary fiber, etc.) contained in young barley grass as active ingredient, and it can be also one not specifying the active ingredients.

Intestinal regulation in the present invention means an action of adjusting the stomach condition. Action of adjusting the stomach condition is a concept encompassing action of ameliorating bowel movement, or action of ameliorating intestinal environment. Action of ameliorating bowel movement, is for example, in a subject having tendency toward constipation, an action of increasing frequency or amount of bowel motion, or action of alleviating abdominal pain associated with constipation, action of ameliorating odor of feces or condition of feces; and in a subject having tendency toward diarrhea, an action of decreasing frequency or level of diarrhea, action of ameliorating abdominal pain associated with diarrhea, and action of ameliorating odor of feces or condition of feces. Action of ameliorating intestinal environment is for example, an action of keeping intestinal flora in good state, or an action of increasing beneficial bacteria or decreasing bad bacteria in the intestines. Therefore, the powder beverage comprising young barley grass of the present invention is useful as composition for ameliorating bowel movement, or composition for ameliorating intestinal environment.

Embodiments of using the powder beverage comprising young barley grass of the present invention as a composition for intestinal regulation can be specifically exemplified by indicating “ameliorating bowel movement”, “ameliorating feces”, “increasing stool frequency, stool amount”, “increasing number of times or amount of feces”, “ameliorating habitude of bowel motion”, “adjusting stool condition (color, odor, amount, form of stool)”, “alleviating abdominal symptoms”, “to those having tendency toward constipation”, “to those who want to adjust stomach condition”, “to those who are aware of stomach condition”, “to those suffering of stomach condition”, “ameliorating intestinal environment”, “ameliorating intestinal environment of large intestine”, “improving intestinal environment”, “improving intestinal flora”, “adjusting intestinal condition”, “increasing bifidobacteria”, “increasing beneficial bacteria”, etc. on any of the main body, package, instructions, or website of product sales of the product.

The powder beverage comprising young barley grass of the present invention exerts an effect of ameliorating bowl motion by increasing fecal wet weight for making egestion to be smooth, as shown in the following Examples.

Further, the powder beverage comprising young barley grass of the present invention exerts an action of ameliorating intestinal environment by increasing the number of bacteria such as lactic bacteria and butyric acid bacteria being useful intestinal bacteria, as shown in the following Examples. Therefore, the powder beverage comprising young barley grass of the present invention is useful as composition for proliferating lactic bacteria or composition for proliferating butyric acid bacteria. Examples of lactic acid bacteria include bacteria belonging to the genus Lactobacillus, and examples of butyric acid bacteria include bacteria belonging to the genus Clostridium cluster XIVa.

### (2) Use Intending Effect of Maintaining or Improving Immunity

Since the powder beverage comprising young barley grass of the present invention exerts an excellent effect of maintaining or improving immunity, it can be used as a composition for maintaining or improving immunity. The powder beverage comprising young barley grass of the present invention increases IgA amount in the gut tract, as shown in the following Examples. Since IgA has an action of preventing infection from bacteria or virus, by the increase of IgA, an effect of maintaining and improving immunity of gut tract is exerted. The powder beverage comprising young barley grass of the present invention is useful as a composition for promoting IgA secretion.

### EXAMPLES

In the following, the present invention is further explained with the Examples. However, the present invention is not limited to these Examples, and as long as the object of the invention can be solved, the present invention can have various embodiments.

### [1. Production of Powder Beverage]

### Example 1

As raw material, aerial part (leaf and stem) of barley, harvested at a height of about 30 cm was used. This was subjected to pretreatment to wash with water to remove attached soil, and to cut to a size of about 5 to 10 cm. Pretreated young barley grass was subjected to blanching treatment with boiling water of 90 to 100° C. for 90 sec to 120 sec only once, and then cooled down with cold water. Then, obtained young barley grass was dried in a drier for 20 min to 180 min, with hot air of 80° C. to 130° C. until the water content becomes 5% by weight or less. Dried young barley grass was subjected to crushing treatment so that median diameter becomes 15 μm, to obtain young barley grass powder (young barley grass crushed powder). This was used as powder beverage of Example 1.

Median diameter of young barley grass was measured by using laser scattering particle size distribution analyzer (LMS-300; manufactured by Seishin Enterprise Co., Ltd.). Measurement conditions were: dispersion medium: ethanol, refraction index: 1.330-0.00i; shape coefficient: 1.000. Median diameters referred to in the following are all measured by the same method as Example 1.

### Example 2

Young barley grass powder of Example 1 was injected in a fluidized-bed granulator, then to young barley grass powder that has been in a fluidized state by supplying air of 55° C., 75% by weight of water with respect to the weight of young barley grass powder was intermittently sprayed. Then, by supplying air of 120° C. for drying, granulated products (water content 5% by weight or less) were obtained. This was used as a powder beverage of Example 2.

### Example 3

Raw material mixed so that it becomes: young barley grass powder of Example 1: 80% by weight, xylo-oligosaccharide 5% by weight; lactose 15% by weight; was injected in a fluidized-bed granulator, then to raw material that has been in a fluidized state by supplying air of 70° C., 50% by weight of water with respect to the total weight of raw material was intermittently sprayed. Then, by supplying air of 100° C. for drying, granulated products (water content 5% by weight or less) were obtained. This was used as a powder beverage of Example 3.

### Example 4

Raw material mixed so that it becomes: young barley grass juice powder (extract juice of young barley grass added with dextrin, and dried for powderization by spray drying; ratio of extract juice of young barley grass and dextrin: 1:1):60% by weight, reduced oligosaccharide 40% by weight; was injected in a fluidized-bed granulator, then to raw material that has been in a fluidized state by supplying air of 70° C., 20% by weight of water with respect to the total weight of raw material was intermittently sprayed. Then, by supplying air at 100° C. for drying, granules (water content 5% by weight or less) were obtained. This was used as a powder beverage of Example 4.

### Example 5

Kale powder (kale subject to crushing treatment to be powderized; median diameter 30 μm) was injected in a fluidized-bed granulator, then to kale powder that has been in a fluidized state by supplying air of 65° C., 80% by weight of water with respect to the weight of kale powder was intermittently sprayed. Then, by supplying air of 80° C. for drying, granulated products (water content 5% by weight or less) were obtained. This was used as a powder beverage of Example 5.

### Example 6

Angelica keiskei powder (Angelica keiskei subject to crushing treatment to be powderized; median diameter 30 μm) was injected in a fluidized-bed granulator, then to Angelica keiskei powder that has been in a fluidized state by supplying air of 65° C., 80% by weight of water with respect to the weight of Angelica keiskei powder was intermittently sprayed. Then, by supplying air of 80° C. for drying, granulated products (water content 5% by weight or less) were obtained. This was used as a powder beverage of Example 6.

### Comparative Example 1

Similar method as Example 1 except that dried young barley grass was subjected to crushing treatment to have a size of about 1 mm (size of median diameter greater than median diameter 30 μm) was performed to obtain young barley grass powder (young barley grass crushed powder). This was used as powder beverage of Comparative Example 1.

### Comparative Example 2

Young barley grass powder of Example 1 was injected in an extrusion granulator, then by being careful to clogging of screen (1 mm screen was used) 10-30% by weight of water with respect to young barley grass powder was appropriately added for granulation, dried in a shelf-type drier by setting the drying temperature at 90° C. for drying to obtain granulated products (water content 5% by weight or less). This was used as powder beverage of Comparative Example 2.

### [2. Assessment of Dispersion Rate]

Based on the following measurement procedure and assessment standard, the dispersion time of powder beverages of Examples 1-6 and Comparative Example 1 was measured, to assess the dispersion rate. The results are shown in Table 1.

### <Measurement Procedure>

Put 100 mL water in a container having a circular truncated cone shape, which inner diameter of a bottom part is 55 mm, inner diameter of a top part is 75 mm, and a height is 100 mm; inject a powder beverage from above 50 mm of a water surface at a rate of 1 g/sec; and measure the time (dispersion time) from when the injection of the powder beverage is terminated to when the powder beverage floating on a liquid surface is submerged in water.

### <Assessment Standard of Dispersion Rate>

A: Very good (dispersion time 1 min or less)
B: Good (dispersion time 2 min or less)
C: Slightly good (dispersion time 5 min or less)
D: Moderate (dispersion time 10 min or less)
E: Bad (dispersion time over 10 min)

TABLE 1

| | | | | | | | Comparative |
|---|---|---|---|---|---|---|---|
| | Example 1 | Example 2 | Example 3 | Example 4 | Example 5 | Example 6 | Example 1 |
| Young barley | 100.0 | 100.0 | 80.0 | | | | |
| grass powder | | | | | | | |
| Median diameter | | | | | | | |
| 30 μm or less | | | | | | | |
| Young barley | | | | | | | 100.0 |
| grass powder | | | | | | | |
| Median diameter | | | | | | | |
| over 30 μm | | | | | | | |
| Young barley | | | | 60.0 | | | |
| grass juice | | | | | | | |
| powder | | | | | | | |
| Kale powder | | | | | 100.0 | | |
| Angelica | | | | | | 100.0 | |
| keiskei powder | | | | | | | |
| xylo- | | | 5.0 | | | | |
| oligosaccharide | | | | | | | |
| lactose | | | 15.0 | | | | |
| reduced | | | | 40.0 | | | |
| oligosaccharide | | | | | | | |
| Total | 100.0 | 100.0 | 100.0 | 100.0 | 100.0 | 100.0 | 100.0 |
| (% by weight) | | | | | | | |
| Granulation | none | fluidized- | fluidized- | fluidized- | fluidized- | fluidized- | none |
| | | bed | bed | bed | bed | bed | |
| | | granulation | granulation | granulation | granulation | granulation | |
| Dispersion rate | B | A | A | A | A | A | E |

As shown in Table 1, while powder beverage consisting of young barley grass powder which median diameter is 30 μm or less (Example 1) had excellent dispersibility, the dispersion rate of the powder beverage consisting of young barley grass powder which median diameter is over 30 μm (Comparative Example 1) was bad. Further, the powder beverages which were made by granulating green leaves of specific plants by fluidized-bed granulation all had excellent dispersion rate (Examples 2-6).

### [3. Assessment of Dispersion Stability]

Based on the following measurement procedure and assessment standard, the separation distance after mixing and allowed to stand still the powder beverages of Examples 1-6 and Comparative Example 2 was measured, to assess the dispersion stability. The results are shown in Table 2.

### <Measurement Procedure of Separation Distance>

Put 100 ml of water in a transparent container having a cylindrical shape, which inner diameter is 75 mm, inject a powder beverage from 50 mm above a water surface at a rate of 1 g/sec, stirring 10 times using a stick which diameter is 5 mm, so as to draw a radius of 25 mm from a center of the container; remove the stick when terminating stirring, allow to stand still for 1 min, and measure a height (separation distance) of a clear upper portion;

After injecting the powder beverage, stirring is started within 3 sec, and the stirring rate is 1 to 1.5 times/sec. When stirring the tip of the stick shall contact the bottom of the container.

### <Assessment Standard of Dispersion Stability>

A: Very good (separation distance less than 3 mm)
B: Good (separation distance less than 5 mm)
C: Slightly good (separation distance less than 7 mm)
D: Moderate (separation distance less than 10 mm)
E: Bad (separation distance 10 mm or more)

TABLE 2

| | | | | | | | Comparative |
|---|---|---|---|---|---|---|---|
| | Example 1 | Example 2 | Example 3 | Example 4 | Example 5 | Example 6 | Example 2 |
| Young barley | 100.0 | 100.0 | 80.0 | | | | 100.0 |
| grass powder | | | | | | | |
| Median diameter | | | | | | | |
| 30 μm or less | | | | | | | |
| Young barley | | | | 60.0 | | | |
| grass juice | | | | | | | |
| powder | | | | | | | |
| Kale powder | | | | | 100.0 | | |
| Angelica | | | | | | 100.0 | |
| keiskei powder | | | | | | | |
| xylo- | | | 5.0 | | | | |
| oligosaccharide | | | | | | | |
| lactose | | | 15.0 | | | | |
| reduced | | | | 40.0 | | | |
| oligosaccharide | | | | | | | |
| Total | 100.0 | 100.0 | 100.0 | 100.0 | 100.0 | 100.0 | 100.0 |
| (% by weight) | | | | | | | |
| Granulation | none | fluidized- | fluidized- | fluidized- | fluidized- | fluidized- | Extrusion |
| | | bed | bed | bed | bed | bed | granulation |
| | | granulation | granulation | granulation | granulation | granulation | |
| Dispersion | A | A | A | A | A | A | E |
| stability | | | | | | | |

As shown in Table 2, the powder beverage consisting of young barley grass powder which median diameter is 30 μm or less (Example 1), and the powder beverages made by granulating green leaves of specific plants by fluidized-bed granulation (Examples 2-6) all had excellent dispersion stability. On the other hand, the powder beverage made by granulating young barley grass powder by extrusion granulation (Comparative Example 2) had bad dispersion stability.

### [4. Assessment of Drinkability]

Based on the following assessment method and assessment standard, the drinkability of the powder beverages of Examples 1-6 and Comparative Examples 1 and 2 was assessed. The results are shown in Table 3.

### <Assessment Method>

3 g of each sample was injected in a drinking cup filled with 100 mL of water. After injection, it was stirred 10 times (stirring rate: 1 to 1.5 times/sec) using a swizzle stick. Immediately after, each beverage was intake, and the going down was assessed using the following assessment standard.

### <Assessment of Drinkability>

◯: do not feel any tickle or almost no tickle in the throat when drinking
x: feel tickle in the throat when drinking

TABLE 3

| | Example | | | | | | Comparative Example | |
|---|---|---|---|---|---|---|---|---|
| | 1 | 2 | 3 | 4 | 5 | 6 | 1 | 2 |
| Young barley grass | 100.0 | 100.0 | 80.0 | | | | | 100.0 |
| powder | | | | | | | | |
| Median diameter 30 | | | | | | | | |
| μm or less | | | | | | | | |
| Young barley grass | | | | | | | 100.0 | |
| powder | | | | | | | | |
| Median diameter over | | | | | | | | |
| 30 μm | | | | | | | | |
| Young barley grass | | | | 60.0 | | | | |
| juice powder | | | | | | | | |
| Kale powder | | | | | 100.0 | | | |
| Angelica keiskei | | | | | | 100.0 | | |
| powder | | | | | | | | |
| xylo-oligosaccharide | | | 5.0 | | | | | |
| lactose | | | 15.0 | | | | | |
| reduced | | | | 40.0 | | | | |
| oligosaccharide | | | | | | | | |
| Total | 100.0 | 100.0 | 100.0 | 100.0 | 100.0 | 100.0 | 100.0 | 100.0 |
| (% by weight) | | | | | | | | |
| Granulation | none | fluidized-bed granulation | | | | | none | Extrusion |
| | | | | | | | | granulation |
| Drinkability | ◯ | ◯ | ◯ | ◯ | ◯ | ◯ | X | X |

As shown in Table 3, the powder beverage consisting of young barley grass powder which median diameter is 30 μm or less (Example 1), and the powder beverages made by granulating green leaves of specific plants by fluidized-bed granulation (Examples 2-6) had good drinkability. On the other hand, the powder beverage consisting of young barley grass powder which median diameter is over 30 μm (Comparative Example 1) and the powder beverage made by granulating young barley grass powder by extrusion granulation (Comparative Example 2) had bad drinkability.

### [5. Powder Beverage Comprising Green Leaves of Specific Plants]

By the method described in the following, granulated products comprising green leaves of specific plants were obtained. These were used as powder beverages of Examples 7-12.

### Example 7

Mulberry leaf powder (obtained by powderizing mulberry leaf by subjecting to crushing treatment; median diameter 30 μm) was injected in a fluidized-bed granulator, then to mulberry leaf powder that has been in a fluidized state by supplying air of 55° C., 80% by weight of water with respect to the weight of mulberry leaf powder was intermittently sprayed. Then, by supplying air of 120° C. for drying, granulated products (water content 5% by weight or less) were obtained. This was used as a powder beverage of Example 7.

### Example 8

Wormwood powder (obtained by powderizing wormwood by subjecting to crushing treatment; median diameter 30 μm) was injected in a fluidized-bed granulator, then to wormwood powder that has been in a fluidized state by supplying air of 55° C., 80% by weight of water with respect to the weight of wormwood powder was intermittently sprayed. Then, by supplying air of 120° C. for drying, granulated products (water content 5% by weight or less) were obtained. This was used as a powder beverage of Example 8.

### Example 9

Peucedanum japonicum powder (obtained by powderizing Peucedanum japonicum by subjecting to crushing treatment; median diameter 30 μm) was injected in a fluidized-bed granulator, then to Peucedanum japonicum powder that has been in a fluidized state by supplying air of 55° C., 80% by weight of water with respect to the weight of Peucedanum japonicum powder was intermittently sprayed. Then, by supplying air of 120° C. for drying, granulated products (water content 5% by weight or less) were obtained. This was used as a powder beverage of Example 9.

### Example 10

Kuma Bamboo Grass powder (obtained by powderizing Kuma to crushing treatment; median Bamboo Grass by subjecting diameter 30 μm) was injected in a fluidized-bed granulator, then to Kuma Bamboo Grass powder that has been in a fluidized state by supplying air of 55° C., 80% by weight of water with respect to the weight of Kuma Bamboo Grass powder was intermittently sprayed. Then, by supplying air of 120° C. for drying, granulated products (water content 5% by weight or less) were obtained. This was used as a powder beverage of Example 10.

### Example 11

Spinach powder (obtained by powderizing spinach by subjecting to crushing treatment; median diameter 30 μm) was injected in a fluidized-bed granulator, then to spinach powder that has been in a fluidized state by supplying air of 55° C., 80% by weight of water with respect to the weight of spinach powder was intermittently sprayed. Then, by supplying air of 120° C. for drying, granulated products (water content 5% by weight or less) were obtained. This was used as a powder beverage of Example 11.

### Example 12

Celery powder (obtained by powderizing celery by subjecting to crushing treatment; median diameter 30 μm) was injected in a fluidized-bed granulator, then to celery powder that has been in a fluidized state by supplying air of 55° C., 80% by weight of water with respect to the weight of celery powder was intermittently sprayed. Then, by supplying air of 120° C. for drying, granulated products (water content 5% by weight or less) were obtained. This was used as a powder beverage of Example 12.

The powder beverages of Examples 7-12 all had excellent dispersibility (dispersion rate and dispersion stability), and had good drinkability.

### [6. Use Intending Effect of Intestinal Regulation, or Effect of Improving Maintenance of Immune Function]

### (1) Production of Powder Beverage Consisting of Young Barley Grass Powder

Similar method as Example 1 except crushing treatment was performed so that median diameter becomes 14.91 μm, 23.75 μm, and 41.85 μm, respectively to obtain young barley grass powder 1-3. These were used as powder beverages.

TABLE 4

| | Young barley | Young barley | Young barley |
|---|---|---|---|
| | grass powder 1 | grass powder 2 | grass powder 3 |
| Median diameter (μm) | 14.91 | 23.75 | 41.85 |

### (2) Preparation of Test Substance

Each obtained young barley grass powder was mixed with AIN-76 refined feed (Table 5) to prepare test substances shown in the following Table 6. Those not added with young barley grass powder, specifically test substance with only AIN-76 refined feed was used as control group. AIN-76 refined feed was prepared by using mortar, muddler, and feeding machine (MT-30H; AICOH MIXERS & AICOH SYSTEMS). Mixing of powder beverage and AIN-76 refined feed was made by using a mortar and a muddler, to make a mixed feed, in which each ingredient is uniform.

TABLE 5

| | Composition (% by weight) |
|---|---|
| Milk casein | 20 |
| DL-methionine | 0.3 |
| Corn starch | 15 |
| Sucrose | 50 |
| Corn oil | 5 |
| Vitamin mixed (AIN-76) | 1 |
| Mineral mixed (AIN-76) | 3.5 |
| Choline bitartrate | 0.2 |
| Cellulose | 5 |
| Total | 100 |

TABLE 6

| | Control | | | |
|---|---|---|---|---|
| Test substance | group | Example 13 | Example 14 | Example 15 |
| ANI-76 refined feed | 100 | 90 | 90 | 90 |
| Young barley grass | | 10 | | |
| powder 1 | | | | |
| Young barley grass | | | 10 | |
| powder 2 | | | | |
| Young barley grass | | | | 10 |
| powder 3 | | | | |
| Total | 100 | 100 | 100 | 100 |

Unit: % by weight

### (3) Test Method

### (Breeding of Test Animals)

Male ICR mice (Kyudo Company) of 4 weeks-old were acclimated for 6 days. As breeding environment, lighting hours were 12 hours, and as cage, a polycarbonate flat-bottom cage (W220× D320× H135 mm; TOYORIKO) using woodchips (soft chips: Japan SLLC, Inc.) for bedding, or a stainless-steel five-chamber cage (W150×D210×H150 mm; Tokiwa Corporation) was used. Number of accommodated animals was 2 to 3 animals per cage for the flat-bottom cage, and 1 animal per chamber for the five-chamber cage. The five-chamber cage was used for collecting feces.

During the acclimation period, the feeding method was in principle free intake. As feed, MF solid feed (Oriental Yeast Co., Ltd.) was used, and for drinking water, tap water was used. After the termination of the acclimation period, heathy test animals were divided into 4 groups (6 animals per group) and subjected to test.

For the 5 weeks-old test animals divided into groups after the termination of the acclimation period, from the test start date (day 0), the animals were allowed to freely intake each test substance for 14 days. As breeding environment, lighting hours were 12 hours, and as cage, a stainless-steel five-chamber cage using woodchips (soft chips: Japan SLC, Inc.) for bedding was used. Number of accommodated animals was 1 animal per chamber. As feeder, for ease of measuring feed consumption, Roden CAFE (Oriental Yeast Co., Ltd.) was used.

Feces were collected at each measurement date, on day 12-14 after starting the test. Feces collected at day 12 and day 13 were cryopreserved at −30° C., and were used as a sample for analyzing fecal IgA level and intestinal flora.

### (Measurement of Fecal Wet Weight, Fecal IgA Level and Intestinal Flora)

Fecal wet weight, fecal IgA level and intestinal flora were measured by the following method.

### (A) Assessment of Fecal Wet Weight

For feces collected at 24 hours on day 14 after starting the test, fecal wet weight was measured. Larger fecal wet weight shows that the effect of ameliorating bowel movement is excellent.

### (B) Assessment of Fecal IgA Level

Fecal IgA level was measured by using Quantitative ELISA kit (Bethyl Laboratories, Montgomery, TX). Specifically, feces at day 13 and 14 of the test were collected, and after drying overnight at room temperature by putting on a plastic tray, they were cryopreserved at −30° C. Then, cryopreserved feces were dried for 2 days under room temperature by using a suction pump and a desiccator. Then, by using a mortar and a muddler, dried feces were crushed. Then, 1 mL PBS was added per 0.1 g of crushed feces, and extracted at room temperature for 1 hour. Then, by centrifugating for removing solid parts, feces extraction liquid was obtained. By using this feces extraction liquid, fecal IgA level was quantified with the above-mentioned Quantitative ELISA kit.

### (C) Assessment of Intestinal Flora

Intestinal flora was analyzed by real-time PCR as follows. Specifically, feces at day 13 and 14 of the test were collected, and after drying at room temperature overnight by putting on a plastic tray, they were cryopreserved at −30° C. Then, after supplying cryopreserved feces to a lyophilizer, crushing was performed. 100 mg per sample was measured, and extraction was performed by following the instructions of DNA extraction kit (QIA amp (registered trademark) DNA Stool Mini Kit; QIAGEN). DNA solution was diluted 50-fold with injection water to make a template.

For the above template, by following the instructions of Real-time PCR kit (QuantiNova SYBR Green master mix; Qiagen), using RoterGene Q (registered trademark; Qiagen), real-time PCR assay was performed (pre-incubation 95° C., 5 min; PCR cycle 95° C., 5 sec 60° C., 10 sec×40 cycles). Subjects of analysis were total bacteria, genus Lactobacillus, genus Prevotella and Clostridium cluster XIVa. Primer sequences listed in the following Table 7 were used.

TABLE 7

| | Type | | SEQ |
|---|---|---|---|
| Name of | of | | ID |
| bacteria | primer | Sequence | No. |
| Total | forward | TCCTACGGGAGGCAGCAGT | 1 |
| bacteria | reverse | GGACTACCAGGGTATCTATCCTGTT | 2 |
| Genus | forward | AGCAGTAGGGAATCTTCCA | 3 |
| Lactobacillus | reverse | ATTTCACCGCTACACATG | 4 |
| Genus | forward | CACRGTAAACGATGGATGCC | 5 |
| Prevotella | reverse | GGTCGGGTTGCAGACC | 6 |
| Clostridium | forward | AAATGACGGTACCTGACTAA | 7 |
| clustar XIVa | reverse | CTTTGAGTTTCATTCTTGCGAA | 8 |

For intestinal flora, control was used as a standard, and it was measured as a relative level with respect to the control.

### (4) Results

The measurement results of fecal wet weight (average value) are shown in Table 8, measurement results of fecal IgA level (average value) are shown in Table 9, and measurement results of intestinal flora (average value of relative value with respect to control group) are shown in Table 10.

TABLE 8

| | Control | | | |
|---|---|---|---|---|
| | group | Example 13 | Example 14 | Example 15 |
| Fecal wet weight (g) | 0.52 | 1.25 | 1.10 | 0.96 |

TABLE 9

| | Control | | | |
|---|---|---|---|---|
| | group | Example 13 | Example 14 | Example 15 |
| Fecal IgA level | 0.80 | 3.25 | 2.60 | 2.59 |
| (mg-IgA/day) | | | | |

TABLE 10

| | Control | | | |
|---|---|---|---|---|
| | group | Example 13 | Example 14 | Example 15 |
| Lactobacillus | 1 | 3.01 | 2.44 | 2.22 |
| Prevotella | 1 | 8039 | 5639 | 4998 |
| Clostridium clustar | 1 | 3.03 | 2.46 | 2.23 |
| XIVa | | | | |

For Examples 13-15, the levels of fecal wet weight, intestinal flora, and fecal IgA level were all superior with respect to control group. From these results, it was confirmed that when using young barley grass as dark-green vegetables of the present invention, an effect of intestinal regulation, and an effect of improving maintenance of immune function are exerted. Further, smaller is the median diameter of young barley grass powder, the tendency that the effect of intestinal regulation and the effect of improving maintenance of immune function being further excellent was confirmed. In Example 13, the most excellent effect of intestinal regulation, and effect of improving maintenance of immune function was exerted.

### INDUSTRIAL APPLICABILITY

Since the powder beverage of the present invention comprises dark-green vegetables, and is a powder beverage having excellent dispersibility, it can be used as foods and drink, and is the industrial applicability is high.

What is claimed is:

1. A powder beverage comprising at least one type of dark-green vegetable, wherein a dispersion time measured by the following procedure is 10 min or less:
<Measurement procedure of dispersion time>
Put 100 mL water in a container having a circular truncated cone shape, which inner diameter of a bottom part is 55 mm, inner diameter of a top part is 75 mm, and a height is 100 mm; inject a powder beverage from above 50 mm of a water surface at a rate of 1 g/sec; and measure the time (dispersion time) from when the injection of the powder beverage is terminated to when the powder beverage floating on a liquid surface is submerged in water.

2. A powder beverage comprising at least one type of dark-green vegetable, wherein a dispersion distance after stirring for 1 min as measured by the following procedure is less than 10 mm:
<Measurement procedure of separation distance>
Put 100 mL of water in a transparent container having a cylindrical shape, which inner diameter is 75 mm, inject a powder beverage from 50 mm above a water surface at a rate of 1 g/sec, stirring 10 times using a stick which diameter is 5 mm, so as to draw a radius of 25 mm from a center of the container; remove the stick when terminating stirring, allow to stand still for 1 min, and measure a height (separation distance) of a clear upper portion.
After injecting the powder beverage, stirring is started within 3 sec, and the stirring rate is 1 to 1.5 times/sec. When stirring the tip of the stick shall contact the bottom of the container.
